(19) United States
(12) Patent Application Publication
(10) Pub. No.: US 2024/0093030 A1
(43) Pub. Date: Mar. 21, 2024

(54) HIGH-STRENGTH AND HIGH-HEAT-RESISTANT BIO-BASED POLYAMIDE COMPOSITION AND PREPARATION METHOD THEREOF

(71) Applicants: SHANGHAI PRET COMPOSITES CO., LTD., Shanghai (CN); ZHEJIANG PRET ADVANCED MATERIALS CO., LTD., Zhejiang (CN); CHONGQING PRET NEW MATERIALS CO., LTD., Chongqing (CN); SHANGHAI PRET CHEMICAL NEW MATERIALS CO., LTD, Shanghai (CN)

(72) Inventors: Haisheng ZHANG, Shanghai (CN); Jianrui CHEN, Zhejiang (CN); Yi WANG, Shanghai (CN); Ruixiang YAN, Shanghai (CN); Ying CAI, Shanghai (CN); Bing ZHOU, Shanghai (CN); Meiling XU, Shanghai (CN); Qianhui ZHANG, Shanghai (CN); Qing CAI, Shanghai (CN); Guoyi DU, Chongqing (CN); Tinglong YAN, Chongqing (CN); Wen ZHOU, Shanghai (CN)

(73) Assignees: SHANGHAI PRET COMPOSITES CO., LTD., Shanghai (CN); ZHEJIANG PRET ADVANCED MATERIALS CO., LTD., Zhejiang (CN); CHONGQING PRET NEW MATERIALS CO., LTD., Chongqing (CN); SHANGHAI PRET CHEMICAL NEW MATERIALS CO., LTD, Shanghai (CN)

(21) Appl. No.: 18/268,308

(22) PCT Filed: Dec. 28, 2021
(86) PCT No.: PCT/CN2021/141935

§ 371 Date: Jun. 19, 2023

(30) Foreign Application Priority Data
Dec. 29, 2020 (CN) 202011597323.5

(51) Int. Cl. C08L 77/06; C08K 13/04

(52) U.S. Cl. CPC C08L 77/06; C08K 13/04; C08K 5/098; C08L 2201/08; C08L 2203/30; C08L 2310/00

(57) ABSTRACT

The present invention provides a high-strength and high-heat-resistant bio-based polyamide composition, which consists of the following parts of materials by mass: 43.50-89.95% of bio-based polyamide resin slices; 10-50% of reinforcements; 0.01-2% of rare earth compounds; 0.01-1% of copper salt antioxidant combinations; 0.01-1% of free-radical scavengers; 0.01-0.5% of heat-conducting masterbatches; 0.01-1% of stabilizers; and 0-1% of dispersants. The advantage of the present invention is presented in that: the bio-based polyamide resin slice is prepared through a stepwise polycondensation process of pentanediamine and adipic acid, or through a stepwise polycondensation process of pentanediamine, adipic acid and terephthalic acid and the pentanediamine is prepared through fermentation of starch, so the prepared polyamide resin pertains to an environmentally-friendly engineering plastic.

### BACKGROUND

### Technical Field

The present invention relates to the technical field of polymer materials, in particular to a high-strength and high-heat-resistant bio-based polyamide composition and a preparation method thereof.

### Description of Related Art

Bio-based materials refer to a new class of renewable biomass produced through biological, chemical and physical methods by using crops, trees, other plants and their residues and inclusions as raw materials, as characterized to be green, resource-saving and environmentally friendly, so it is a major focus of the future development of materials. According to the research report released by Occasm Research, the current global output of bio-based chemicals and polymer materials is about 50 million tons, and their output value reckons to reach 10 billion˜15 billion US dollars by 2021. The Bio-based material helps to solve the problems of resource and energy shortage and environmental pollution confronted with global economic and social development, as one of the intense competitive fields involving the development of new materials in the today's world.

Polyamide materials, as an engineering plastic, have excellent mechanical properties, wear resistance, self-lubricating properties and heat resistance, and are widely used in automobiles, electronic appliances, power tools, special equipment and other fields, so how to continuously improve the mechanical properties and heat resistance of polyamide materials is an intense competitive point involving the research of polyamide materials in recent years.

The China patent CN 110229515A has disclosed that by selecting a polyamide slice with high-end amino and low-end carboxyl and adding an epoxy resin in the conceived formula, the surface of the polyamide composition generates a “protective shield”, which can effectively hinder the contact between polyamide and oxygen and reduce the generation of free-radicals in a high-temperature environment, and has passed through a thermo-oxidative aging test under 210*1000 h and 230° C.*1000 h to give about 80% as the bending strength retention rate of PA66-GF35 before and after long-term thermo-oxidative aging. The U.S. patent U.S. Ser. No. 15/190,934 has disclosed that a dense oxidation film can be quickly formed on the resin surface by means of citric acid and EDTA under the function of high temperature, functioning in hindrance of oxygen, so that the mechanical property retention rate of the mixed resin PA6T and PA66 reinforced with glass fibers improves at 180° C. and 1000 h. The Europe patent EP11873964.8 has disclosed a polyamide resin with a melting point of 280° C. prepared and modified by means of a filler, a light-resistant supplement, an aging-resistant supplement and a processing agent, which is used to manufacture LED parts. The international patent PCT/CN/2019/070352 has disclosed that a polyamide resin composition prepared in addition with ketone carbonyl polymer containing ketone carbonyl as well as alkali metal salt compound has excellent resistance to long-term thermo-oxidative aging and good resistance to hydrothermal aging at 85° C. and under the relative humidity of 90%, and PA66-GF30 left at 85° C. and under the relative humidity of 90% for 21 days and undergoing 1000 h aging processing at 150° C. still enables its tensile strength retention rate to be up to 92%, which is suitable for a harsh application environment. However, the currently-disclosed patents mostly aim to study the long-term thermo-oxidative aging performance of petroleum-based polyamide compositions, rather than specifical research for long-term thermo-oxidative aging of bio-based polyamides, and have made some improvements just by synthesizing higher heat-resistant resins, enhancing the hindrance of oxygen on the surface of polyamide and adopting antioxidants, or by other single means, resulting in difficulty to balance performance and economic benefits, as well as aging processing conditions required only at 150-230° C. and for 1000 h, or a requisite high-temperature long-term thermo-oxidative aging test after left at 80° C. and under the relative humidity of 90%. The polyamide compositions are necessarily used in the environment of thermo-oxidative aging (210-230° C.) alternately combined with high temperature and high humidity (85° C., 85% RH) under the actual operation conditions for automobiles, but the existing patents are provided with the test conditions, which differ from the operation conditions of an automobile engine system, failing to objectively reflect the material properties under real operation conditions and limiting the application range of polyamide compositions.

### SUMMARY

In order to solve the above technical problem in the prior art, the present invention provides a high-strength and high-heat-resistant bio-based polyamide composition and a preparation method thereof, for simulating the operation environment of the automobile engine system, and the bio-based polyamide composition prepared through the method has an excellent mechanical property retention rate under the conditions of the alternating test between the long-term thermo-oxidative aging at 210-230° C. for 3000 h and the long-term hydrothermal aging at 85° C. and 85% RH for 3000 h.

The present invention is executed with the following technical solutions.

A high-strength and high-heat-resistant bio-based polyamide composition consists of the following parts of materials by mass:
43.50-89.95% of bio-based polyamide resin slices;
10-50% of reinforcements;
0.01-2% of rare earth compounds;
0.01-1% of copper salt antioxidant combinations;
0.01-1% of free-radical scavengers;
0.01-0.5% of heat-conducting masterbatches;
0.01-1% of stabilizers; and
0-1% of dispersants.

The bio-based polyamide resin slice is a kind of bio-based polyamide resin slices PA56 prepared through a stepwise polycondensation process of pentanediamine and adipic acid, or a kind of bio-based polyamide resin slices PA56T prepared through a stepwise polycondensation process of pentanediamine, adipic acid and terephthalic acid, among them, the pentanediamine is prepared through fermentation of starch, the content of the bio-based mass in the PA56 slice is 45% (by mass), the melting point of the PA56 slice is 235-260° C., and its relative viscosity is 2.7±0.5; the content of the bio-based mass in the PA56T slice is 40% (by mass), the melting point of the PA56T slice is 255-275° C., and its relative viscosity is 2.6±0.5. Preferably, the melting point of the PA56 slice is 255° C.; the melting point of the PA56T slice is 267° C.

The reinforcement may be one or more of a glass fiber, a carbon fiber, a basalt fiber and other fiber-like fillers. Preferably, in this method, the reinforcement is a glass fiber, which has an alkali content of <0.8%, a volume density of 0.50-0.8 g/cm³, a monofilament diameter of 6-18 μm, a chopped length of 3 mm and a moisture content of ≤0.05%.

The metal ions in the rare earth compound are selected from the elements of Group IIIB in the periodic table, preferably lanthanum. The anions paired with the metal ions may be at least one of an oxygen ion, an acetate ion, a carbonate ion, a nitrate ion and a halogen anion, preferably one of an acetate ion or an oxygen ion.

The copper salt antioxidant combination is a complex of potassium halide and cuprous halide or organic chelate, which is compounded at the ratio of (3-16):1, preferably, the halide element is iodine or bromine.

The free-radical scavenger is a carbon-centered free-radical scavenger serving as a multifunctional lactone-type heat stabilizer and antioxidant, which belongs to a benzofuranone system. Its structural formula is as follows.

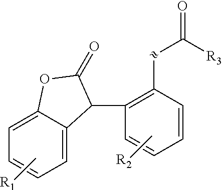

The heat-conducting masterbatch is a single-wall carbon nanotube with high thermal conductivity, carried by an ester lubricant synthesized from aliphatic acid and pentaerythritol; the active ingredient content of the carbon nanotube in the heat-conducting masterbatch is 10%-20%, the thermal conductivity of the carbon nanotube is >10 W/mK, and the heat-conducting masterbatch is prepared from a banburying process.

The processing stabilizer is N,N-bis(2,2,6,6-tetramethyl-4-pyridyl)-1,3-benzenedicarboxamide, which has a molecular weight of 442.64, a melting point of 270-274° C. and CAS No. of 42774-15-2; it has a very good effect for the stabilization of the melt occurring during processing polyamide materials.

The dispersant is a kind of partially-saponified montan ester wax with a dropping point of 95-100° C. and an acid value of 10-25 mg KOH/g.

The preparation method of the bio-based polyamide composition includes the following steps:
(1) enabling the moisture content of the bio-based polyamide resin slice not to exceed 2000 ppm;
(2) weighing the various materials that have dried up according to the formula proportion, then evenly mixing the bio-based polyamide resin slices, the rare earth compounds, the copper salt antioxidant combinations, the free-radical scavengers, the heat-conducting masterbatches, the stabilizers and the dispersants by means of a high-speed mixer and leaving them for use, furthermore, weighing the reinforcements according to the formula proportion and leaving them for use; and
(3) adding the mixture of the above resin and supplements through the main feed opening of a twin-screw extruder, and adding the reinforcements through the side feed opening of the twin-screw extruder, then successively performing a melting-extruding process, a granulating process, a drying process and other processes, finally obtaining the high-strength and high-heat-resistant bio-based polyamide material.

The above bio-based polyamide composition can be applied to an inlet chamber of intercoolers, an inlet manifold of compact turbochargers, a charge air cooler and other components of an automotive engine system.

The advantage of the present invention is presented in that: the bio-based polyamide resin slice is prepared through a stepwise polycondensation process of pentanediamine and adipic acid, or through a stepwise polycondensation process of pentanediamine, adipic acid and terephthalic acid, among them, the pentanediamine is prepared through fermentation of starch, so the prepared polyamide resin pertains to an environmentally-friendly engineering plastic, furthermore, in order to fill a gap in the technical field of the high heat resistance of bio-based polyamide materials, we introduce the rare earth compounds, the copper salt antioxidant combinations, the free-radical scavengers, the heat-conducting masterbatches and other ingredients into the formula design, endowing the bio-based polyamide materials with excellent resistance to long-term thermo-oxidative aging, and a tensile strength retention rate more than 50% after the alternating test between the long-term hydrothermal aging at 85° C. and 85% RH and the long-term thermo-oxidative aging at 210-230° C. Therefore, as the material is characterized with an environmental protection concept and a high performance, it can replace metal materials or special engineering plastics such as PPA, PPS, PA66, etc., so as to meet the requirements applied to an inlet chamber of intercoolers, an inlet manifold of compact turbochargers, a charge air cooler and other components of the automotive engine system.

The present invention has the following beneficial effects.

(1) In the present invention, the resin is selectable as one of bio-based polyamides PA56 and PA56T, and has merit in the aspect of environmental protection. Compared with the conventional PA6 and PA66 structures, PA56 has high density of amide bonds and low molecular chain regularity, thus this difference in structure brings with the performance effects such as the characteristics of high water absorption and low crystallinity of PA56 relative to PA6, PA66 and other materials, and fairly big difference in the long-term thermo-oxidative aging performance relative to PA6 and PA66, particularly in the alternating test between the long-term hydrothermal aging and the long-term thermo-oxidative aging, so the present invention enables the bio-based polyamides PA56, PA56T to be applied for long time in a high temperature environment.

2) In the present invention, the long-term thermo-oxidative aging test of the bio-based polyamide composition is executed in combination with a high temperature and high humidity environment (85° C., 85% RH), so it is more suitable for the operation environment of automotive engine system materials.

3) The rare earth compound is added into the formula design, then the rare earth compound, the copper salt and the amide bond interact with each other, so that a special atomic structure is formed at the “rare earth-copper” interface by making use of the activation of the rare earth on the cooper salt, achieving an unexpected effect in greatly improving the long-term thermo-oxidative aging performance of bio-based polyamides; furthermore, by making use of differential characteristic in the ability of the rare earth compound to bind oxygen atoms during heating and cooling, the present invention enhances the anti-aging performance of polyamide in the environment of periodic thermo-oxidative aging combined with periodic high temperature and high humidity and fills a gap in this technical field.

4) The present invention selects a single-wall carbon nanotube with high thermal conductivity as the heat-conducting masterbatch, so that the surface of the polyamide composition can quickly carbonize to form a “protective shield” in a high-temperature environment, which can effectively hinder the contact between polyamide and oxygen, and reduce the generation of free-radicals in the high-temperature environment. In a high-temperature and high-humidity environment, on the one hand, the surface-carbonizing layer acts as a first layer for sealing and shielding, on the other hand, the internal carbon nanotubes form a nanonetwork structure to hinder water molecules as a second barrier.

5) The aging mechanism of polyamide materials brings with carbon radicals, which react with oxygen to form peroxide radicals, and the carbon radicals have a high half-life period of only 10⁻³ to 10⁻⁶ seconds, and strong activity, so it is difficult to scavenge them, for the conventional antioxidants can only scavenge peroxyl radicals with a long half-life period, but the free-radical scavengers used in the present invention has high reactivity and high efficiently scavenges carbon radical generated from polyamide in a high temperature environment, enhancing the long-term thermo-oxidative aging performance of polyamide materials. Furthermore, the stabilizers introduced into the formula has a very good effect in stabilizing the melt and the supplements during processing, raising the processing stability of the bio-based polyamide composition.

The bio-based polyamide composition achieves the performance of high strength and resistance to long-term heat oxygen aging based on the above beneficial effect, and is characterized with an environmental protection concept and a high performance.

### DESCRIPTION OF THE EMBODIMENTS

In order to make the technical problem to be solved in the present invention, the technical solution and the beneficial effect clearer, the present invention will be further described in detail in combination with the following examples.

The examples and of the controls in the present invention adopt the following materials, but not limited to the following materials:

The polyamide resin PA56, commercially named Ecopent E-1273, which is produced by Shanghai Cathay Biotechnology Co., Ltd

The polyamide resin PA56T, commercially named Ecopent E-2260, which is produced by Shanghai Cathay Biotechnology Co., Ltd.

The polyamide resin PA66, commercially named EPR27, which is produced by Shenma Engineering Plastics Co., Ltd.

The polyamide resin PA66/6T, commercially named EP523HT, which is produced by the polyamide division of Huafeng Group Co., Ltd.

The lanthanum acetate, which is purchased from Shanghai Maclean Biochemical Technology Co., Ltd.

The lanthanum oxide, which is purchased from Shanghai Maclean Biochemical Technology Co., Ltd.

The glass fiber, commercially named ECS301HP-3, which is produced by Chongqing International Composite Materials Co., Ltd.

The copper salt antioxidant combination with a KI-to-CuI mass ratio of 9:1, which is commercially available.

The free-radical scavenger, commercially named Revonox 501, which is produced by Chitec Technology Co., Ltd.

The single-wall carbon nanotube with thermal conductivity of >10 W/mK, which is commercially available.

The stabilizer, commercially named S-EED, which is produced in Suqian Zhenxing Chemical Co., Ltd.

The dispersant, commercially named LICOWAX OP, which is produced by CLARIANT.

The antioxidant 1098, a hindered phenolic antioxidant, which is commercially available.

The antioxidant 168, a phosphite antioxidant, which is commercially available.

The preparation methods of Examples 1-20 and Controls 1-18 are stated below.

Preparing the bio-based polyamide composition.

Weighing the various materials that have dried up according to the formula proportion, then evenly mixing the bio-based polyamide resin slices, the rare earth compounds, the copper salt antioxidant combinations, the free-radical scavengers, the heat-conducting masterbatches, the stabilizers and the dispersants by means of a high-speed mixer; then weighing the reinforcements according to the formula proportion; next adding the mixture of the above resin and supplements through the main feed opening of a twin-screw extruder, and adding the reinforcements through the side feed opening of the twin-screw extruder, then successively performing a melting-extruding process under the twin-screw extruder at 220-300° C., a granulating process, a drying process and other processes, finally obtaining the high-strength and high-heat-resistant bio-based polyamide material.

Preparing a sampling strip of the bio-based polyamide composition.

The above materials are dried in a blowing drying oven at 120° C. for 4 h and then molded into a standard trip at an injection temperature of 280-300° C. Some physical properties are tested on the molded sampling strip after adjusting its state for 24 hours in a laboratory standard environment (23° C., 50% RH).

Test methods for each performance index.

The tensile properties are tested according to ISO 527 method with a sampling strip having a size of 170*10*4 mm and at a test speed of 5 mm/min.

The flexural properties are tested according to ISO 178 method with a sampling strip having a size of 80*10*4 mm and at a test speed of 2 mm/min.

The notched impact properties are tested according to ISO 179 method with a sampling strip having a size of 80*10*4 mm.

The tensile strength retention rate-A: 1) making a state adjustment on the molded sampling strip in a laboratory environment, then recording its tensile strength tested in accordance with the ISO 527 as a tensile strength before aging; 2) continuously placing the standard sampling strip in an oven at 210° C. or 230° C. for 3000 h, then making a state adjustment on the sampling strip in a laboratory environment (23° C., 50% RH) for 24 h, next recording its tensile strength tested in accordance with the ISO 527 as a tensile strength-A after aging; 3) calculating the tensile strength retention rate-A according to the tensile strength before aging/the tensile strength-A after aging*100%.

The tensile strength retention rate-B: 1) making a state adjustment on the molded sampling strip in a laboratory environment, then recording its tensile strength tested in accordance with the ISO 527 as a tensile strength before aging; 2) continuously placing the standard sampling strip in an oven at 210° C. or 230° C. for 144 h, then cooling it to room temperature, next placing it in an environmental box at 85° C. and 85% RH for 24 h with an alternative repeat, and continuously leaving it for 21 alternative repeats, after finishing aging, drying up the sampling strip in an oven at 100° C. to a constant weight, after that, making a state adjustment on the sampling strip in a laboratory environment (23° C., 50% RH) for 24 h, next recording its tensile strength tested in accordance with the ISO 527 as a tensile strength-B after aging; 3) calculating the tensile strength retention rate-B according to the tensile strength before aging/the tensile strength-B after aging*100%.

Table 1, the constituent and performance of the bio-based polyimide composition in Example 1-10.

| | | Exam- | Exam- | Exam- | Exam- | Exam- | Exam- | Exam- | Exam- | Exam- | Exam- |
|---|---|---|---|---|---|---|---|---|---|---|---|
| Constituent | | ple 1 | ple 2 | ple 3 | ple 4 | ple 5 | ple 6 | ple 7 | ple 8 | ple 9 | ple 10 |
| PA56 | | 68.2 | 67.7 | 67.2 | 68.2 | 67.7 | 67.2 | 67.8 | 67.9 | 63.2 | 48.2 |
| Glass fiber | | 30 | 30 | 30 | 30 | 30 | 30 | 30 | 30 | 35 | 50 |
| Rare earth | Lanthanum | 0.5 | 1 | 1.5 | | | | 0.5 | 0.5 | 0.5 | 0.5 |
| compound | acetate | | | | | | | | | | |
| | Lanthanum | | | | 0.5 | 1 | 1.5 | | | | |
| | oxide | | | | | | | | | | |
| Copper salt | KI:CuI = | 0.2 | 0.2 | 0.2 | 0.2 | 0.2 | 0.2 | 0.2 | 0.5 | 0.2 | 0.2 |
| antioxidant | 9:1 | | | | | | | | | | |
| combination | | | | | | | | | | | |
| Free-radical | Revonox | 0.2 | 0.2 | 0.2 | 0.2 | 0.2 | 0.2 | 0.2 | 0.2 | 0.2 | 0.2 |
| scavenger | 501 | | | | | | | | | | |
| Heat-conducting | | 0.1 | 0.1 | 0.1 | 0.1 | 0.1 | 0.1 | 0.5 | 0.1 | 0.1 | 0.1 |
| masterbatch | | | | | | | | | | | |
| Stabilizer | S-EED | 0.5 | 0.5 | 0.5 | 0.5 | 0.5 | 0.5 | 0.5 | 0.5 | 0.5 | 0.5 |
| Dispersant | LICOWAX | 0.3 | 0.3 | 0.3 | 0.3 | 0.3 | 0.3 | 0.3 | 0.3 | 0.3 | 0.3 |
| | OP | | | | | | | | | | |

| | | | | | | | | | | |
|---|---|---|---|---|---|---|---|---|---|---|
| Flexural modulus | 8265 | 8298 | 8306 | 8175 | 8269 | 8251 | 8329 | 8462 | 9378 | 14206 |
| Notch impact strength | 10.3 | 9.6 | 9.2 | 10.8 | 9.5 | 9.3 | 10.4 | 10.6 | 11.2 | 12.8 |
| Tensile strength | 182.5 | 180.3 | 178.2 | 184.2 | 183.1 | 183.5 | 184.8 | 185.2 | 193.2 | 221.6 |
| Tensile strength after | 116.8 | 119 | 119.4 | 114.2 | 115.3 | 115.6 | 120.1 | 122.2 | 125.6 | 150.7 |
| aging-A | | | | | | | | | | |
| Tensile strength retention | 64 | 66 | 67 | 62 | 63 | 63 | 65 | 66 | 65 | 68 |
| rate-A | | | | | | | | | | |
| Tensile strength after | 109.5 | 111.8 | 114.0 | 121.5 | 124.5 | 126.6 | 112.7 | 116.7 | 119.8 | 141.8 |
| aging-B | | | | | | | | | | |
| Tensile strength retention | 60 | 62 | 64 | 66 | 68 | 69 | 61 | 63 | 62 | 64 |
| rate-B | | | | | | | | | | |

Table 2, the constituent and performance of the bio-based polyimide composition in Control 1-9.

| | | Con- | Con- | Con- | Con- | Con- | Con- | Con- | Con- | Con- |
|---|---|---|---|---|---|---|---|---|---|---|
| Constituent | | trol1 | trol2 | trol3 | trol4 | trol5 | trol6 | trol7 | trol8 | trol9 |
| PA56 | | 68.4 | 68.7 | 69 | | 69.5 | 69.1 | 69.1 | 68.9 | 68.7 |
| PA66 | | | | | 69 | | | | | |
| Glass fiber | | 30 | 30 | 30 | 30 | 30 | 30 | 30 | 30 | 30 |
| Rare earth | Lanthanum | 0.5 | | 0.5 | 0.5 | | | | | 0.5 |
| compound | acetate | | | | | | | | | |
| | Lanthanum | | | | | | | | | |
| | oxide | | | | | | | | | |
| Copper salt | KI:CuI = 9:1 | | 0.2 | 0.2 | 0.2 | 0.2 | 0.2 | | | 0.2 |
| antioxidant | | | | | | | | | | |
| combination | | | | | | | | | | |
| Free-radical | Revonox 501 | 0.2 | 0.2 | | | | | 0.2 | 0.2 | 0.2 |
| scavenger | | | | | | | | | | |
| Heat-conducting masterbatch | | 0.1 | 0.1 | | | | | | 0.1 | 0.1 |
| Stabilizer | S-EED | 0.5 | 0.5 | | | | | | 0.5 | |
| Dispersant | LICOWAX | 0.3 | 0.3 | 0.3 | 0.3 | 0.3 | 0.3 | 0.3 | 0.3 | 0.3 |
| | OP | | | | | | | | | |
| Antioxidant | 1098 | | | | | | 0.2 | 0.2 | | |
| Antioxidant | 168 | | | | | | 0.2 | 0.2 | | |

| | | | | | | | | | |
|---|---|---|---|---|---|---|---|---|---|
| Flexural modulus | 8359 | 8481 | 8317 | 8752 | 8756 | 8791 | 8703 | 8695 | 8248 |
| Notch impact strength | 10.5 | 10.2 | 10.6 | 10.8 | 10.7 | 10.4 | 10.5 | 10.6 | 10.1 |
| Tensile strength | 184.3 | 185.9 | 186.8 | 189.3 | 188.5 | 187.2 | 187.8 | 186.9 | 181.9 |
| Tensile strength after aging- | 11.1 | 13.0 | 102.7 | 106 | 9.4 | 11.2 | 9.4 | 9.3 | 114.6 |
| A | | | | | | | | | |
| Tensile strength retention | 6 | 7 | 55 | 56 | 5 | 6 | 5 | 5 | 63 |
| rate-A | | | | | | | | | |
| Tensile strength after aging- | 9.2 | 11.1 | 84.0 | 94.6 | 5.6 | 5.6 | 5.6 | 5.6 | 107.3 |
| B | | | | | | | | | |
| Tensile strength retention | 5 | 6 | 45 | 50 | 3 | 3 | 3 | 3 | 59 |
| rate-B | | | | | | | | | |

Table 3, the constituent and performance of the bio-based polyimide composition in Example 11-20.

| | | Exam- | Exam- | Exam- | Exam- | Exam- | Exam- | Exam- | Exam- | Exam- | Exam- |
|---|---|---|---|---|---|---|---|---|---|---|---|
| | | ple | ple | ple | ple | ple | ple | ple | ple | ple | ple |
| Constituent | | 11 | 12 | 13 | 14 | 15 | 16 | 17 | 18 | 19 | 20 |
| PA56T | | 68.2 | 67.7 | 67.2 | 68.2 | 67.7 | 67.2 | 67.8 | 67.9 | 63.2 | 48.2 |
| Glass fiber | | 30 | 30 | 30 | 30 | 30 | 30 | 30 | 30 | 35 | 50 |
| Rare earth | Lanthanum | 0.5 | 1 | 1.5 | | | | 0.5 | 0.5 | 0.5 | 0.5 |
| compound | acetate | | | | | | | | | | |
| | Lanthanum | | | | 0.5 | 1 | 1.5 | | | | |
| | oxide | | | | | | | | | | |
| Copper salt | KI:CuI = | 0.2 | 0.2 | 0.2 | 0.2 | 0.2 | 0.2 | 0.2 | 0.5 | 0.2 | 0.2 |
| antioxidant | 9:1 | | | | | | | | | | |
| combination | | | | | | | | | | | |
| Free-radical | Revonox | 0.2 | 0.2 | 0.2 | 0.2 | 0.2 | 0.2 | 0.2 | 0.2 | 0.2 | 0.2 |
| scavenger | 501 | | | | | | | | | | |
| Heat-conducting | | | 0.1 | 0.1 | 0.1 | 0.1 | 0.1 | 0.5 | 0.1 | 0.1 | 0.1 |
| masterbatch | | | | | | | | | | | |
| Stabilizer | S-EED | 0.5 | 0.5 | 0.5 | 0.5 | 0.5 | 0.5 | 0.5 | 0.5 | 0.5 | 0.5 |
| Dispersant | LICOWAX | 0.3 | 0.3 | 0.3 | 0.3 | 0.3 | 0.3 | 0.3 | 0.3 | 0.3 | 0.3 |
| | OP | | | | | | | | | | |

| | | | | | | | | | | |
|---|---|---|---|---|---|---|---|---|---|---|
| Flexural modulus | 8432 | 8486 | 8543 | 8405 | 8472 | 8556 | 8329 | 8771 | 9562 | 14521 |
| Notch impact strength | 9.5 | 9.1 | 9.0 | 10.0 | 9.7 | 9.8 | 9.9 | 10.3 | 10.6 | 12.8 |
| Tensile strength | 185.2 | 183.6 | 172.1 | 184.8 | 184.5 | 183.2 | 186.9 | 187.2 | 195.6 | 226.2 |
| Tensile strength after | 124.1 | 124.8 | 117 | 118.2 | 121.8 | 122.7 | 127.1 | 127.3 | 133 | 160.6 |
| aging-A | | | | | | | | | | |
| Tensile strength retention | 67 | 68 | 68 | 64 | 66 | 67 | 68 | 68 | 68 | 71 |
| rate-A | | | | | | | | | | |
| Tensile strength after | 116.7 | 119.3 | 111.8 | 125.7 | 127.3 | 126.4 | 115.8 | 117.9 | 129.1 | 156.1 |
| aging-B | | | | | | | | | | |
| Tensile strength retention | 63 | 65 | 65 | 68 | 69 | 69 | 62 | 63 | 66 | 69 |
| rate-B | | | | | | | | | | |

Table 4, the constituent and performance of the bio-based polyimide composition in Control 10-18.

| | | Con- | Con- | Con- | Con- | Con- | Con- | Con- | Con- | Con- |
|---|---|---|---|---|---|---|---|---|---|---|
| Constituent | | trol 10 | trol 11 | trol 12 | trol 13 | trol 14 | trol 15 | trol 16 | trol 17 | trol 18 |
| PA56 | | 68.4 | 68.7 | 69 | | 69.5 | 69.1 | 69.1 | 68.9 | 68.7 |
| PA66 | | | | | 69 | | | | | |
| Glass fiber | | 30 | 30 | 30 | 30 | 30 | 30 | 30 | 30 | 30 |
| Rare earth | Lanthanum | 0.5 | | 0.5 | 0.5 | | | | | 0.5 |
| compound | acetate | | | | | | | | | |
| | Lanthanum | | | | | | | | | |
| | oxide | | | | | | | | | |
| Copper salt | KI:CuI = 9:1 | | 0.2 | 0.2 | 0.2 | 0.2 | 0.2 | | | 0.2 |
| antioxidant | | | | | | | | | | |
| combination | | | | | | | | | | |
| Free-radical | Revonox 501 | 0.2 | 0.2 | | | | | 0.2 | 0.2 | 0.2 |
| scavenger | | | | | | | | | | |
| Heat-conducting masterbatch | | 0.1 | 0.1 | | | | | | 0.1 | 0.1 |
| Stabilizer | S-EED | 0.5 | 0.5 | | | | | | 0.5 | |
| Dispersant | LICOWAX | 0.3 | 0.3 | 0.3 | 0.3 | 0.3 | 0.3 | 0.3 | 0.3 | 0.3 |
| | OP | | | | | | | | | |
| Antioxidant | 1098 | | | | | | 0.2 | 0.2 | | |
| Antioxidant | 168 | | | | | | 0.2 | 0.2 | | |

| | | | | | | | | | |
|---|---|---|---|---|---|---|---|---|---|
| Flexural modulus | 8685 | 8808 | 8712 | 8981 | 9015 | 8882 | 8915 | 8786 | 8382 |
| Notch impact strength | 10.2 | 9.8 | 10.1 | 10.3 | 10.5 | 10.2 | 10.4 | 10.6 | 9.3 |
| Tensile strength | 186.6 | 188.3 | 185.1 | 190.6 | 189.7 | 187.3 | 188.2 | 187.6 | 184.6 |
| Tensile strength after aging- | 13 | 11.2 | 105.5 | 112.4 | 13.3 | 15.0 | 15.0 | 11.3 | 123.7 |
| A | | | | | | | | | |
| Tensile strength retention | 7 | 6 | 57 | 59 | 7 | 8 | 8 | 6 | 67 |
| rate-A | | | | | | | | | |
| Tensile strength after aging- | 11.2 | 9.4 | 88.8 | 101 | 9.5 | 13.1 | 11.3 | 9.4 | 116.3 |
| B | | | | | | | | | |
| Tensile strength retention | 6 | 5 | 48 | 53 | 5 | 7 | 6 | 5 | 63 |
| rate-B | | | | | | | | | |

It can be seen from the results of the examples and the controls listed in Table 1, Table 2, Table 3 and Table 4, that the difference in supplement systems has little effect on the mechanical properties of bio-based polyimide compositions, such as the mixture of phosphite, hindered phenols and free-radical scavengers (Control 7, Control 16), the single addition of conventional copper salt heat stabilizers (Control 5, Control 14), or the addition of copper salt heat stabilizers with hindered phenolic antioxidant (Control 6, Control 15) almost don't contribute to improving the heat aging resistance of bio-based polyamide systems. The difference in material structure causes the tensile strength retention rate of bio-based polyamide PA56 in the same formula system to become lower than that of PA66 system after the alternating test between the hydrothermal aging for 500 h and the thermo-oxidative aging at 210-230° C. for 3000 h (Controls 3-4, Controls 12-13). The material formula system composed of bio-based polyamide resins, reinforcements, rare earth compounds, copper salt combinations, heat-conducting masterbatches, stabilizers and free-radical scavengers (Examples 1-20) can keep its tensile strength retention rate more than 60% after the alternating test between the hydrothermal aging for 500 h and the thermo-oxidative aging at 210-230° C. for 3000 h, but the material formula system composed of bio-based polyamide resins, reinforcements, rare earth compounds and copper salt combinations, (Control 3, Control 12) only keeps its tensile strength retention rate more than 50% after the test of the thermo-oxidative aging at 210-230° C. for 3000 h, and the addition of heat-conducting masterbatches, stabilizers and free-radical scavengers makes a contribution in further raising its tensile strength retention rate by 15-20% (Example 1 vs Control 3, Example 11 vs Control 12). Therefore, the present invention has filled a gap in the technical field for the resistance to long-term thermal aging of bio-based polyamide materials, being of great significance for the application of bio-based polyamide materials.

1. A high-strength and high-heat-resistant bio-based polyamide composition, consisting of following parts of materials by mass:
43.50-89.95% of a bio-based polyamide resin slice;
10-50% of a reinforcement;
0.01-2% of a rare earth compound;
0.01-1% of a copper salt antioxidant combination;
0.01-1% of a free-radical scavenger;
0.01-0.5% of a heat-conducting masterbatch;
0.01-1% of a stabilizer; and
0-1% of a dispersant.

2. The high-strength and high-heat-resistant bio-based polyamide composition according to claim 1, wherein the bio-based polyamide resin slice is a bio-based polyamide resin slice PA56 prepared through a first stepwise polycondensation process of pentanediamine and adipic acid, or a bio-based polyamide resin slice PA56T prepared through a second stepwise polycondensation process of pentanediamine, adipic acid and terephthalic acid.

3. The high-strength and high-heat-resistant bio-based polyamide composition according to claim 2, wherein the pentanediamine is prepared through fermentation of starch, a content of a bio-based mass in the bio-based polyamide resin slice PA56 is 45% by mass, a melting point of the bio-based polyamide resin slice PA56 is 235-260° C., and a relative viscosity of the bio-based polyamide resin slice PA56 is 2.7±0.5; a content of a bio-based mass in the bio-based polyamide resin slice PA56T is 40% by mass, a melting point of the bio-based polyamide resin slice PA56T is 255-275° C., and a relative viscosity of the bio-based polyamide resin slice PA56T is 2.6±0.5.

4. The high-strength and high-heat-resistant bio-based polyamide composition according to claim 3, wherein the melting point of the bio-based polyamide resin slice PA56 is 255° C., and the melting point of the bio-based polyamide resin slice PA56T is 267° C.

5. The high-strength and high-heat-resistant bio-based polyamide composition according to claim 1, wherein the reinforcement is one or more of a glass fiber, a carbon fiber, and a basalt fiber.

6. The high-strength and high-heat-resistant bio-based polyamide composition according to claim 5, wherein the reinforcement is the glass fiber, the glass fiber has an alkali content of <0.8%, a volume density of 0.50-0.8 g/cm³, a monofilament diameter of 6-18 μm, a chopped length of 3 mm and a moisture content of ≤0.05%.

7. The high-strength and high-heat-resistant bio-based polyamide composition according to claim 1, characterized in that, wherein a metal ion in the rare earth compound is selected from elements of Group IIIB in periodic table, and an anion paired with the metal ion is at least one of an oxygen ion, an acetate ion, a carbonate ion, a nitrate ion and a halogen anion.

8. The high-strength and high-heat-resistant bio-based polyamide composition according to claim 7, wherein the metal ion in the rare earth compound is selected from lanthanum, and the anion is the acetate ion or the oxygen ion.

9. The high-strength and high-heat-resistant bio-based polyamide composition according to claim 1, wherein the copper salt antioxidant combination is a complex of potassium halide and cuprous halide or organic chelate, the complex is compounded at a ratio of (3-16):1, a halide element is iodine or bromine.

10. The high-strength and high-heat-resistant bio-based polyamide composition according to claim 1, wherein the free-radical scavenger is a carbon-centered free-radical scavenger serving as a multifunctional lactone-type heat stabilizer and antioxidant, the free-radical scavenger belongs to a benzofuranone system, and a structural formula of the free-radical scavenger is as follows:

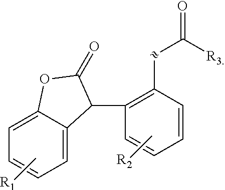

11. The high-strength and high-heat-resistant bio-based polyamide composition according to claim 1, wherein the heat-conducting masterbatch is a single-wall carbon nanotube with high thermal conductivity, a carrier of the heat-conducting masterbatch is an ester lubricant synthesized from aliphatic acid and pentaerythritol, an active ingredient content of the carbon nanotube in the heat-conducting masterbatch is 10%-20%, a thermal conductivity of the carbon nanotube is >10 W/mK, and the heat-conducting masterbatch is prepared from a banburying process.

12. The high-strength and high-heat-resistant bio-based polyamide composition according to claim 1, wherein the processing stabilizer is N,N-bis(2,2,6,6-tetramethyl-4-pyridyl)-1,3-benzenedicarboxamide, having a molecular weight of 442.64, a melting point of 270-274° C. and CAS No. of 42774-15-2.

13. The high-strength and high-heat-resistant bio-based polyamide composition according to claim 1, wherein the dispersant is a kind of partially-saponified montan ester wax with a dropping point of 95-100° C. and an acid value of 10-25 mg KOH/g.

14. A preparation method of the high-strength and high-heat-resistant bio-based polyamide composition according to claim 1, comprising following steps:
(1) enabling a moisture content of the bio-based polyamide resin slice not to exceed 2000 ppm;
(2) weighing various raw materials that have dried up according to a formula proportion, then evenly mixing the bio-based polyamide resin slice, the rare earth compound, the copper salt antioxidant combination, the free-radical scavenger, the heat-conducting masterbatch, the stabilizer and the dispersant by means of a high-speed mixer and leaving them for use, next weighing the reinforcements according to the formula proportion and leaving them for use; and
(3) adding a mixture of the raw materials and a supplement through a main feed opening of a twin-screw extruder, and adding the reinforcement through a side feed opening of the twin-screw extruder, then successively performing a melting-extruding process, a granulating process, and a drying process and other processes, finally obtaining the high-strength and high-heat-resistant bio-based polyamide material.

15. An application of the high-strength and high-heat-resistant bio-based polyamide composition according to claim 1, wherein the bio-based polyamide composition is used in an inlet chamber of intercoolers, an inlet manifold of compact turbochargers, and a charge air cooler of an automotive engine system.
